(19) United States
(12) Patent Application Publication
(10) Pub. No.: US 2018/0029750 A1
(43) Pub. Date: Feb. 1, 2018

(54) Method and Apparatus for Blow-Moulded Stackable Receptacles

(71) Applicant: YUMIX LLC, Dallas, TX (US)

(72) Inventors: James M. Sheely, Toledo, OH (US); Eric Brunella, Sylvania, OH (US); Alex Garner, Temperance, MI (US); Tracy Momany, Sylvania, OH (US); Lori Bartman, Sylvania, OH (US); Bruce Ankenbrandt, Maumee, OH (US)

(73) Assignee: YUMIX LLC, Dallas, TX (US)

(21) Appl. No.: 15/662,108

(22) Filed: Jul. 27, 2017

Related U.S. Application Data
(60) Provisional application No. 62/367,383, filed on Jul. 27, 2016.

(51) Int. Cl. B65D 21/02; B29C 49/48; B65D 1/02

(52) U.S. Cl. CPC B65D 21/0231; B65D 1/0246; B65D 1/0276; B29C 49/4802; B29K 2067/003

(57) ABSTRACT

A blow-molded stackable receptacle comprises a first blow-molded component defining a first blow-molded component axial opening at a first end and an axial recess at a second end, wherein the axial recess is defined by a longitudinal wall comprising at least one ridge or tab and a second blow-molded component defining a second blow-molded component axial opening at a mating end, wherein the axial recess of the first blow-molded component is configured to receive the mating end of the second blow-molded component, wherein the at least one ridge or tab is configured to retain the mating end of the second blow-molded component. At least one method is further disclosed.

### CROSS-REFERENCE TO RELATED APPLICATION(S)

The present application is related to co-pending U.S. Patent Application Ser. No. 62/367,383, entitled “METHOD AND APPARATUS FOR BLOW-MOLDED STACKABLE RECEPTACLES” filed on Jul. 27, 2016 (Attorney Docket No. 578-101-V1), the entirety of which is herein incorporated by reference.

### BACKGROUND

### Field of the Disclosure

This disclosure relates generally to blow-molded stackable receptacles, in particular receptacles interconnected through a latching mechanism and capable of receiving heated or cooled materials for combination.

### Background of the Disclosure

Blow-molded, stackable receptacles can be found in use for a variety of product packaging. For example, receptacles containing the liquids can often be stacked and connected for ease of transportation or sale. While existing receptacles may provide multiple containers of the same size and fill material, having fill materials of differing temperatures, or containers of varying sizes interconnected, can lead to design and functionality issues including factors such as design, molding technique, and latching means.

As an example, receptacles containing hot filled material traditionally have very little space at the top of the container. This allows for the steam that may accumulate at the top of the bottle to exert less force on the container when the fill material comes to room temperature. When a larger space is required at the top of the container, issues with material strength and design can arise. As another example, when the receptacles differ in size and design, problems with the latching means may be encountered when accounting for differing weights and fill materials.

Additionally, traditional blow-molding techniques teach a colder molding temperature for the base of the container than for the side walls, in order to allow for the base to set and to avoid distortion and shrinkage of the receptacle. This technique can encounter issues when the base requires a hotter mold temperature to account for design or fill. For example, if the design of the container requires features such as tabs or undercuts, more complex mechanical actions may be necessary to maintain the desired features during removal. As a specific example, if tabs are required along the outer or inner walls of the container, a base molded at a colder temperature may encounter problems with the tabs breaking off when removed from the molding tool. This may require additional equipment and actions such as a mold with a collapsible core to allow for the container to be removed from the mold without interference or tab breakage. These additional steps and design considerations can lead to manufacturing issues causing delays in production and/or costly redesign. Accordingly, improvements are sought in receptacles differing in shape, size, and fill material.

### SUMMARY OF THE DISCLOSURE

While the way that the present disclosure addresses the disadvantages of the prior art will be discussed in greater detail below, in general, the present disclosure describes a plurality of interconnected stackable receptacles, improving filling and portability aspects.

In some embodiments, a first receptacle includes a sealing feature, a cylindrical body, a bottom circular standing ring, and a bottom cylindrical rise. In some embodiments, the bottom cylindrical rise is adjacent to the bottom circular standing ring and extends upward, internally through the center of the cylindrical body. In yet another embodiment, the bottom cylindrical rise has one or more tabs extending outward into the cylindrical rise. Still in other embodiments, the cylindrical body may include a top neck having a diameter less than the cylindrical body. In other embodiments, the sealing feature may be located adjacent to the top neck and may include a twistable cap having internal threading corresponding to threading on the finish of the receptacle. In further embodiments, the cylindrical body is curved.

Another aspect of the disclosed subject matter features, in some embodiments, a second receptacle including a top sealing feature, a top neck, a cylindrical body, and a bottom circular standing ring. The top neck may have a diameter less than the cylindrical body and include ribbing such as a collar (e.g., bead) between the finish and the top neck. In other embodiments, the top neck of the second receptacle is secured inside the cylindrical rise of the first receptacle by the use of a snap fit connection, such as a connection with the ribbing, interlocking the two receptacles. In yet another embodiment, the top sealing feature is a lift and peel seal.

Another aspect of the disclosed subject matter features, in some embodiments, filling the first receptacle with a first liquid and filling the second receptacle with a second liquid. In other embodiments, the first liquid and the second liquid differ in temperature. In yet another embodiment, the first liquid is a hot liquid and the second liquid is a cold liquid. In further embodiments, the first receptacle is filled with the hot liquid leaving a large space at the top of the first receptacle for the second liquid to be combined with the first liquid within the first receptacle.

Accordingly, the present disclosure provides improved interconnected and stackable receptacles.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures.

FIG. 1 is a side elevation view of a first receptacle according to one embodiment.

FIG. 2 is a bottom view of a bottom cylindrical rise of the first receptacle of FIG. 1 in accordance with at least one embodiment.

FIG. 3 is a side elevation view of a second receptacle according to one embodiment.

FIG. 4 is a side cross-sectional view of the first receptacle and the second receptacle in an interconnected position in accordance with at least one embodiment.

FIG. 5 is a side cross-sectional view of the first receptacle and the neck of the second receptacle in an interconnected position with the first receptacle filled in accordance with at least one embodiment.

FIG. 6 is a side elevation view diagram illustrating a first blow-molded component of a blow-molded stackable receptacle in accordance with at least one embodiment.

FIG. 7 is a bottom plan view diagram illustrating a first blow-molded component of a blow-molded stackable receptacle in accordance with at least one embodiment.

FIG. 8 is a cross-sectional view diagram illustrating a first blow-molded component of a blow-molded stackable receptacle in accordance with at least one embodiment.

FIG. 9 is a cross-sectional view diagram illustrating a first blow-molded component of a blow-molded stackable receptacle in accordance with at least one embodiment.

FIG. 10 is a circular inset view diagram illustrating a portion of the cross-sectional view diagram of FIG. 9 in accordance with at least one embodiment.

FIG. 11 is a circular inset view diagram illustrating a portion of the cross-sectional view diagram of FIG. 8 in accordance with at least one embodiment.

FIG. 12 is a circular inset view diagram illustrating a portion of the side elevation view diagram of FIG. 6. in accordance with at least one embodiment.

FIG. 13 is a perspective view diagram illustrating a first blow-molded component of a blow-molded stackable receptacle in accordance with at least one embodiment.

FIG. 14 is a flow diagram illustrating a method for forming a first blow-molded component and a second blow-molded component, wherein a blow-molded stackable receptacle comprises the first blow-molded component and the second blow-molded component, in accordance with at least one embodiment.

FIG. 15 is a flow diagram illustrating a method for filling and unitizing the components of a blow-molded stackable receptacle in accordance with at least one embodiment.

### DETAILED DESCRIPTION

The following descriptions of exemplary embodiments are not intended to limit the scope, applicability or configuration of the invention. Rather, the following description provides a convenient illustration for implementing various embodiments. As will become apparent, various changes may be made in the function and arrangement of the elements described in these embodiments without departing from the scope of the disclosure as set forth herein. It should be appreciated that the description herein may be adapted to be employed with alternatively configured devices having different shapes, components, capabilities, compositions and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

The blow-molded receptacles described herein provide interconnected containers of different shapes and sizes that allow for a hot-filled process to take place involving a first receptacle and a cold-filled process to take place involving a second receptacle. The first receptacle is designed to allow for a larger than normal headspace, thus creating the need for a design and material that can withstand the force of the vapor in the headspace, as it cools to room temperature, and allowing for sufficient space for the contents of the second cold-filled receptacle to be deposited into the headspace of the first receptacle for combination. The receptacles are sealed and connectable through a latching mechanism described herein.

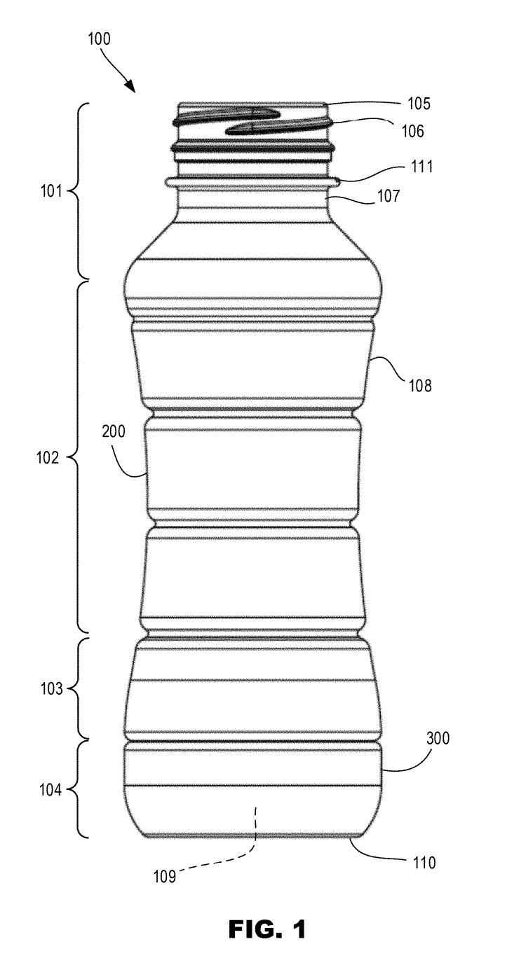

With reference to FIG. 1, depicting a side elevation view of a unitized receptacle 100 comprising a first receptacle 200 and a second receptacle 300, in some embodiments the first receptacle 200 of a first size has a sealing feature 105, a cylindrical body 108, a bottom circular standing ring, and a bottom cylindrical rise (not depicted). Additionally shown in FIG. 1, embodiments of the first receptacle 200 may also contain a neck 107 located at the top of the first receptacle 200. The sealing feature of the first receptacle 200 may be located adjacent to the neck 107 and may comprise threading 106 along the exterior of a finish that interconnects with a twistable cap having corresponding internal threading. Other embodiments of the first receptacle 200 may employ other forms of sealing. The sealing feature 105 may be smaller in diameter than the cylindrical body 108, which may vary in diameter along the length of the body 102. In accordance with at least one embodiment, sealing feature 105 may be implemented as a screw cap, a snap cap, a press-fit cap, a crown cap, a flexible seal, such as a lift and peel seal, or another type of sealing feature.

Also shown in FIG. 1, in some embodiments, the first receptacle 200 has a bottom circular standing ring located at a bottom end of the first receptacle 200. The circular standing ring borders an internal cylindrical rise described herein. The standing ring allows for the first receptacle 200 to sit level on a surface without the need for the second receptacle 300 to be latched into place.

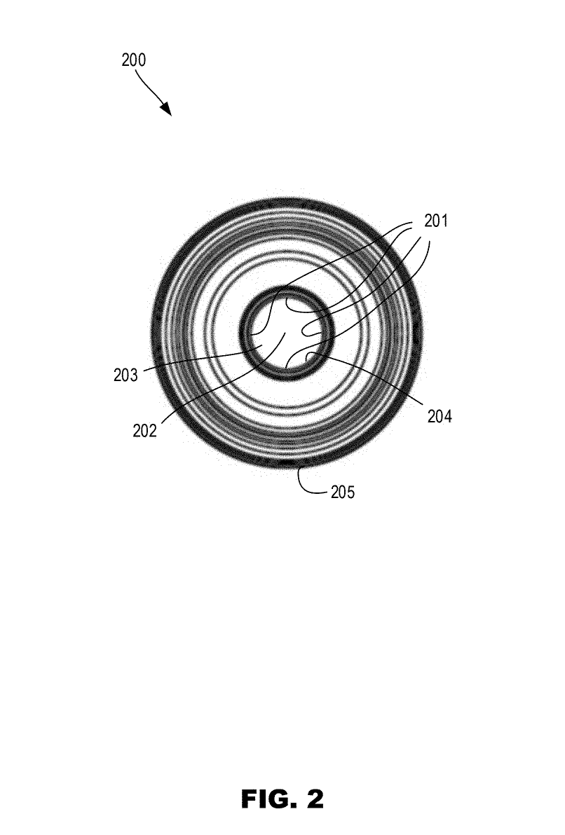

With reference now to FIG. 2, a bottom view of the first receptacle 200 is depicted, wherein the bottom cylindrical rise 204 can be seen. In some embodiments, the bottom cylindrical rise 204 is bordered by the circular standing ring 205 and extends upward, internally through the center 202 of the lower portion 103 of cylindrical body 102 of the first receptacle 200. In some embodiments, the bottom cylindrical rise 204 may employ one or more tabs 201, located along the external surface of the cylindrical rise 204. These tabs 201 may be undercut and inward facing, in some embodiments. In further embodiments, the thickness of the tabs 201 is of a certain range, dependent upon the support needed to successfully interconnect and disconnect the two receptacles due to receptacle material, fill material, etc. In FIG. 2, four tabs 201 are shown for exemplary purposes, but the number of tabs 201 may vary depending on the shape, material, and blow-molding process used for the first receptacle 200 and the second receptacle 300.

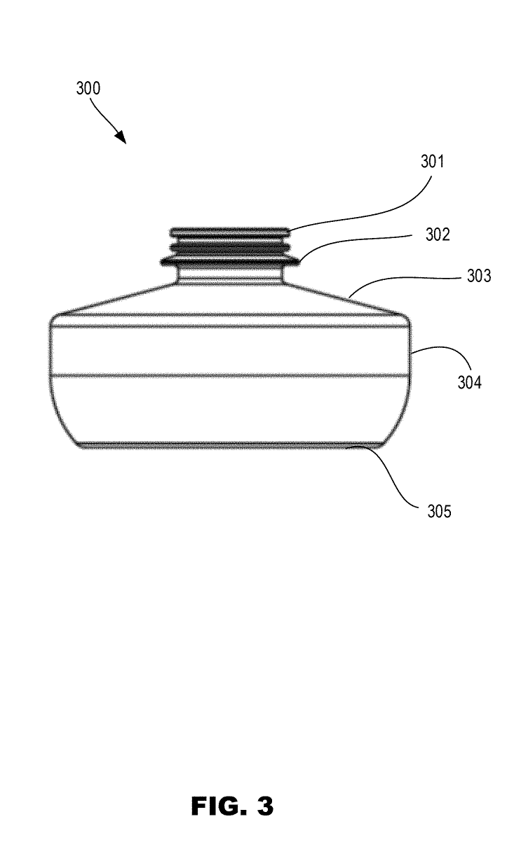

With reference now to FIG. 3, depicting a side elevation view of a second receptacle 300, in some embodiments, a second receptacle 300 of a second size has a sealing feature 301, a shoulder 303, a cylindrical body 304, and a bottom circular standing ring 305. The shoulder 303 may have a diameter less than the cylindrical body 304. One or more ribs 111 may extend outwardly laterally from above the neck above shoulder 303 and below the finish. Additionally, in some embodiments, the sealing feature 301 may be a lift and peel seal (not depicted). The lift and peel seal may be implemented by use of a cap-less conduction sealing, in some embodiments. The bottom standing ring 305, in some embodiments, allows for the second receptacle 300 to sit level on a surface without the need for the first receptacle 200 to be latched into place. The bottom standing ring 305, in some embodiments, can allow the unitized receptacle 100 comprising the first receptacle 100 and the second receptacle 200 to sit level on a surface.

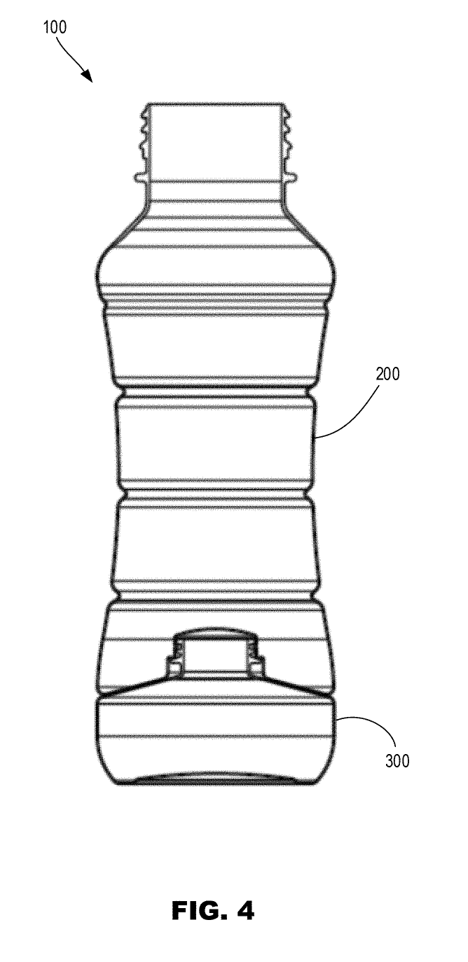

With reference now to FIG. 4, depicting a side cross-sectional view of the first receptacle 200 and the second receptacle 300 in an interconnected position, in some embodiments the first receptacle 200 and the second receptacle 300 are interconnected for ease of transportation and storage, as well as to allow the cold-filled material of the second receptacle 300 to be easily combined with hot-filled material of the first receptacle 200. As previously described with reference to FIGS. 1 and 2, the first receptacle 200 implements a bottom cylindrical rise 204 having one or more tabs 201 (four tabs are shown in FIG. 2 for exemplary purposes). Also previously described with reference to FIG. 3, the second receptacle 300 implements a shoulder 303 reducing diameter to a neck above which are disposed one or more ribs 302 extending outwardly laterally from above the neck above shoulder 303. The one or more ribs 302 are separated by at least the width of the one or more tabs 201, thereby allowing sufficient room for the one or more tabs 201 of the bottom cylindrical rise to fit securely between the one or more ribs 302. The one or more ribs 302 of the second receptacle 300 are locked into the bottom cylindrical rise 204 of the first receptacle 200 via the one or more tabs 201, thereby creating a snap fit connection and securing the second receptacle 300 to the first receptacle 200.

In some embodiments, a specific ratio of thickness of the tabs 201 of the bottom cylindrical rise 204 to diameter of the ribbing 302 of the second receptacle 300 is required for successful interconnection and disconnection of the first receptacle 200 and the second receptacle 300. This ratio may be dictated by several factors including, but not limited to, the manufacturing materials of the two receptacles, the fill material, the amount of fill material contained in each receptacle, etc.

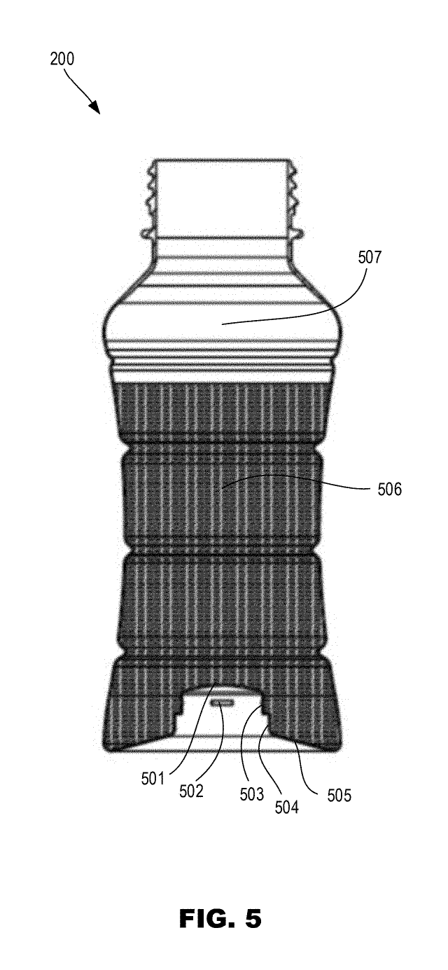

With reference now to FIG. 5, a side cross-sectional view of the first receptacle 200 with the first receptacle 200 filled with liquid 506 is depicted. The headspace 507 located at the top of the first receptacle 200 shown in FIG. 5 is of a sufficient volume to allow the fill material of the second receptacle 300 to be combined with the fill material of the first receptacle 200. The headspace volume of headspace 507 may vary depending on the fill material of the two receptacles. Having a headspace 507 of a larger volume than those seen in the art may be accompanied by some challenges in the blow-molding process. For example, in some embodiments, the first receptacle 200 depicted in FIG. 5 is hot-filled, thereby allowing steam to form in the headspace volume. When the steam comes to room temperature, a vacuum like effect is placed on the first receptacle 200 and exerts a pressure on the container. Suitable materials and cooling time can be used in order to account for these forces. As an example, a plastic material of greater thickness than that typically used for ordinary bottles may be used to accommodate the force from atmospheric pressure in relation to the partially evacuated headspace 507.

FIG. 5 illustrates details of features of the first receptacle 200 that can provide a reliable interconnection of the first receptacle 200 and the second receptacle 300, as depicted in FIG. 1. A dome-like clearance 501, or the cylindrical rise 204 described above, provides sufficient room to account for any sagging that may result after the first receptacle 200 has been removed from the blow-mold tooling. In the example illustrated in FIG. 5, the cylindrical rise 204 comprises a lower cylindrical rise 504 of a relatively larger diameter and an upper cylindrical rise 503 of a relatively smaller diameter. In that example, a tab 502 is seen projecting from the surface of upper cylindrical rise 503. A sufficiently large cylindrical rise can be manufactured to allow for sagging while preventing wasted space between the first receptacle and the second receptacle. A conical rise 505 is provided to stably engage shoulder 303 of second receptacle 300 when first receptacle 200 is conjoined with second receptacle 300.

A variety of tooling materials may also be used in order to prevent wearing of the tooling and a lack of definition. An example of a suitable tooling material includes, but is not limited to, beryllium copper, a material that is of sufficient hardness. Once molded, the receptacles are released from the tool at a time, temperature, and cross-section thickness that allows the material to be pliable enough to be removed without distortion, but does not dramatically change shape after removal. The temperature of the receptacle material upon removal and time for molding is based on such factors as the thickness of the material, the pre-form temperature, mold tooling temperature, fill material, and design considerations.

As described above, traditional blow-molding techniques teach the walls of the receptacle and the base of the receptacle to be molded at different temperatures, with the base normally having a colder mold temperature than the walls of the receptacle. This difference in temperature is employed to allow the base to set and avoid shrinkage and distortion. Operating blow-molding equipment with a blow-molding temperature for the base that is hotter allows for ease of removal from the molding tools at the end of the blow cycle.

For example, as described above, some embodiments comprise a first receptacle having one or more tabs located along the surface of the cylindrical rise. Problems may be encountered during the removal process of a receptacle having such tabs. Accordingly, a manufacturing process that allows for the base to be molded at a hotter temperature, for a rapid removal time from the molding tools, and for a cross-section of a specific thickness to maintain the elasticity of the base upon removal.

More specifically, if the base of the receptacle is manufactured at a colder temperature, the tabs may be compromised or break off upon removal from the tooling. This may require redesign or the use of additional mechanical actions such as using a mold with a collapsible core. As described herein, a hotter blow-molding temperature allows for removal of the tabbed base at a temperature that allows for the plastic to be in an elastic state, herein referred to as the glass transition state (TG). This elasticity allows for the receptacle to be removed with ease and allows for the receptacle material to be flexible enough for both removal and to allow the material to snap back into place and maintain the desired tabs.

In addition to running the base mold at a hotter temperature, the receptacle is has a removal time from the mold tooling that is rapid enough for the container, specifically the base, to maintain elasticity. Also, in addition to the hotter temperature and rapid removal, a cross-section of the base can be thin enough to maintain elasticity during, and shortly after, the removal. The hotter molding temperature, rapid removal from the molding tools, and sufficiently thin cross-section of the receptacle material allow for the container to be removed from the mold tooling without compromising design features such as tabs.

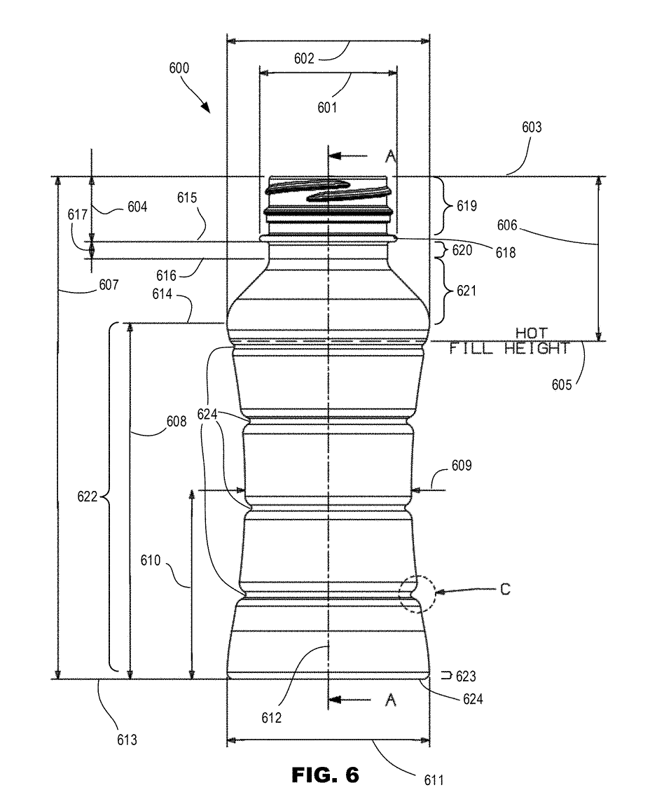

FIG. 6 is a side elevation view diagram illustrating a first blow-molded component of a blow-molded stackable receptacle in accordance with at least one embodiment. First blow-molded component 600 has a collar diameter 601, a maximum shoulder and upper body diameter 602, an upper finish height 603, a finish and collar length 604, a hot fill height 605, a headspace length 606, an entire length 607, a body and insweep length 608, a mid-body diameter 609, a lower body and insweep length 610, a maximum insweep and lower body diameter 611, an axis 612, a heel height 613, an upper body height 614, an upper neck height 615, an upper shoulder height 616, and a neck length 617. Collar diameter 601 is a diameter of collar 618, which is in the form of a bead (e.g., annular rib) below the finish 619 and above the neck 620. Maximum shoulder and upper body diameter 602 is the maximum diameter of shoulder 621 at the lower extreme of shoulder 621 and the maximum diameter of the upper end of body 622. Mid-body diameter 609 is the diameter of body 622 at or near the midpoint of its length. Maximum insweep and lower body diameter 611 is the maximum diameter of insweep 623 and the maximum diameter of the lower end of body 622. Body 622 has a rotationally symmetric convex shape, such that mid-body diameter 609 is less than maximum shoulder and upper body diameter 602 and is also less than maximum insweep and lower body diameter 611.

Upper finish height 603 is a height of the upper end of finish 619 along the length of first blow-molded component 600. Finish and collar length 604 is a combined length of finish 619 and collar 618 in an axial direction relative to axis 612 of first blow-molded component 600. Hot fill height 605 is a height to which a liquid-phase product is to be filled in first blow-molded component 600. The liquid-phase product may be warmer than ambient temperature, such as warmed to a sanitarily safe (hot) temperature, before filling the first blow-molded component 600 to the hot fill height 605. Headspace length 606 is a length of a headspace above hot fill height 605 but below upper finish height 603. The headspace volume corresponding to headspace length 606 is filled with vapor-phase product (e.g., in air) above the liquid-phase product. The vapor-phase product (e.g., and any air) in the headspace volume may change pressure (e.g., in accordance with the ideal gas law) as the temperature changes. Thus, if the first blow-molded component is hot-filled with product at a warmer-than-ambient temperature, subsequent cooling may reduced the pressure of the vapor-phase product (e.g., and any air) relative to ambient pressure. First blow-molded component 600 provides features to accommodate the reduced pressure. For example, the plastic material (e.g., polyethylene terephthalate (PETE)) of first blow-molded component 600 may be thicker than typical blow-molded bottle plastic. As another example, the rotationally symmetric convex shape of first blow-molded component 600 can help accommodate reduced internal pressure. As yet another example, grooves 624 help reinforce the structure of first blow-molded component 600.

Entire length 607 is an entire length of first blow-molded component 600 from upper finish height 603 to heel height 613. Body and insweep length 608 is the combined length of body 622 and insweep 623. Insweep 623 is of insubstantial length relative to the length of body 622, allowing the contour of body 622 to unobtrusively merge with a contour of a body of a second blow-molded component, such as second receptacle 300, which may be fitted into the bottom of first blow-molded component 600. For example, insweep 623 can have a height less than or equal to a height of one of grooves 624. As another example, insweep 623 can have a radius of curvature similar to a radius of curvature of one of grooves 624.

Lower body and insweep length 610 is a combined length of a lower portion of body 623 and insweep 624. As with other lengths described herein with respect to first blow-molded component 600, lower body and insweep length 610 is measured in an axial direction parallel to axis 612 of first blow-molded component 600.

Heel height 613 is a height of a heel 624 of first blow-molded component 600, which is a base height against which other heights may be measured. Upper body height 614 is a height of an upper end of body 622 of first blow-molded component 600, which is at the lower end of shoulder 621. Upper neck height 615 is a height of an upper end of neck 620, which is at the lower end of collar 618. Upper shoulder height 616 is a height of an upper end of shoulder 621, which is at the lower end of neck 620. Neck length 617 is the length of neck 620.

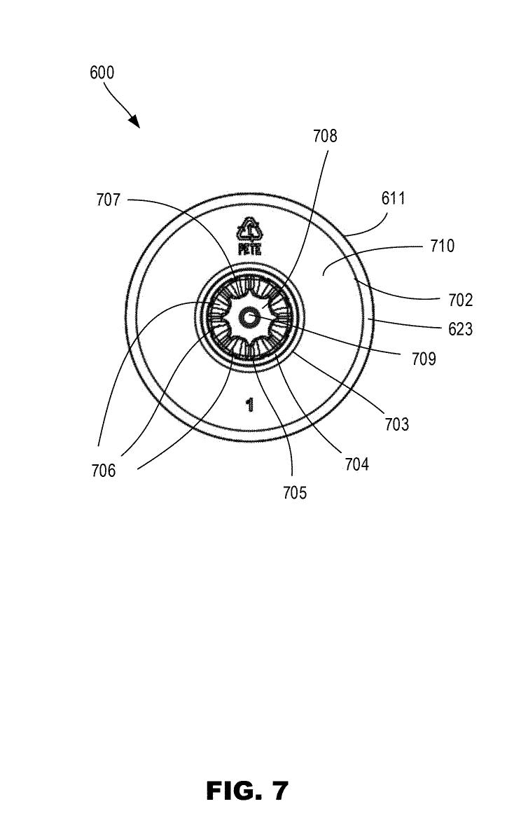

FIG. 7 is a bottom plan view diagram illustrating a first blow-molded component of a blow-molded stackable receptacle in accordance with at least one embodiment. Maximum insweep and lower body diameter 611 can be seen in FIG. 7. Minimum insweep diameter 702 is of a smaller diameter than maximum insweep and lower body diameter 611 and lies between insweep 623 and push-up 710. Between circle 703 and circle 704, which are concentric and are centered at axis 612, is a radiused transition from push-up 710 to an axial recess extending upward from push-up 710 at the central portion of the bottom of first blow-molded component 600. Inside circle 705, which is smaller than circle 704 but is concentric with circles 703 and 704 and centered at axis 612, are longitudinal ridges protruding convexly from a longitudinal wall of the axial recess. The longitudinal ridges can be continued onto pedals 706, which extend inward toward center 709 along a domed portion 708 of the axial recess, reaching a greatest inward extent at edge 707.

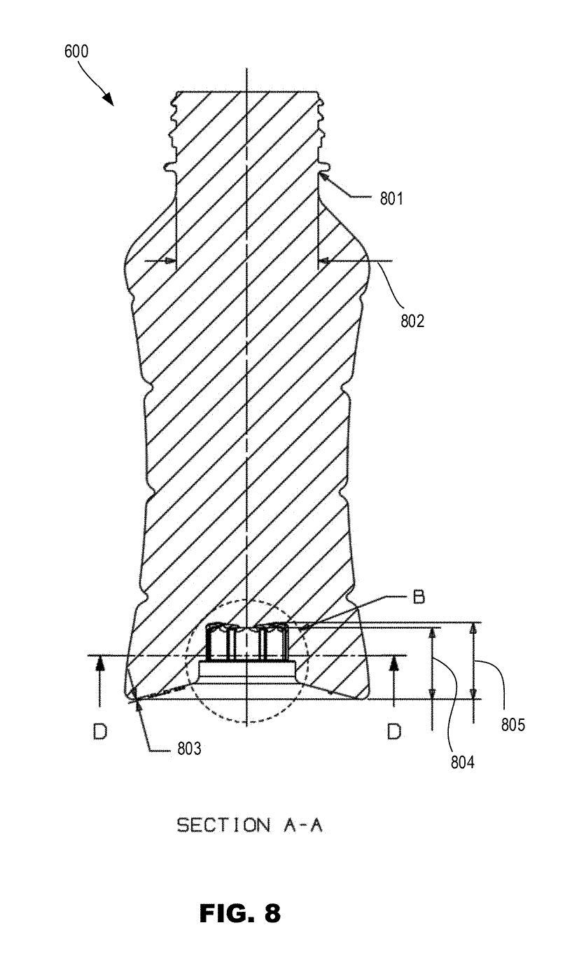

FIG. 8 is a cross-sectional view diagram illustrating a first blow-molded component of a blow-molded stackable receptacle in accordance with at least one embodiment. Upper neck diameter 802 is shown as the diameter at the upper end 801 of neck 620 of first blow-molded component 600. A raised lettering dimension 803 shows a thickness from a surface of push-up 710 of lettering molded within the extent of push-up 710. Center length 804 is a center recess length from the heel height to the height of center 709. Domed portion length 805 is a domed portion recess length from the heel height to the height of an apex of a pedal 706 forming the domed portion of the axial recess within first blow-molded component 600. As can be seen, the recessed area in the bottom of first blow-molded component 600 can accommodate receiving the finish 619, collar 618, neck 620, and shoulder 621 of a second blow-molded component, such as second receptacle 300. Longitudinal ridges oriented in an axial direction and protruding inwardly from a longitudinal wall of generally cylindrical shape within the axial recess of first blow-molded component 600 can engage and retain, for example, a collar or cap of the second blow-molded component within the recessed area in the bottom of first blow-molded component 600.

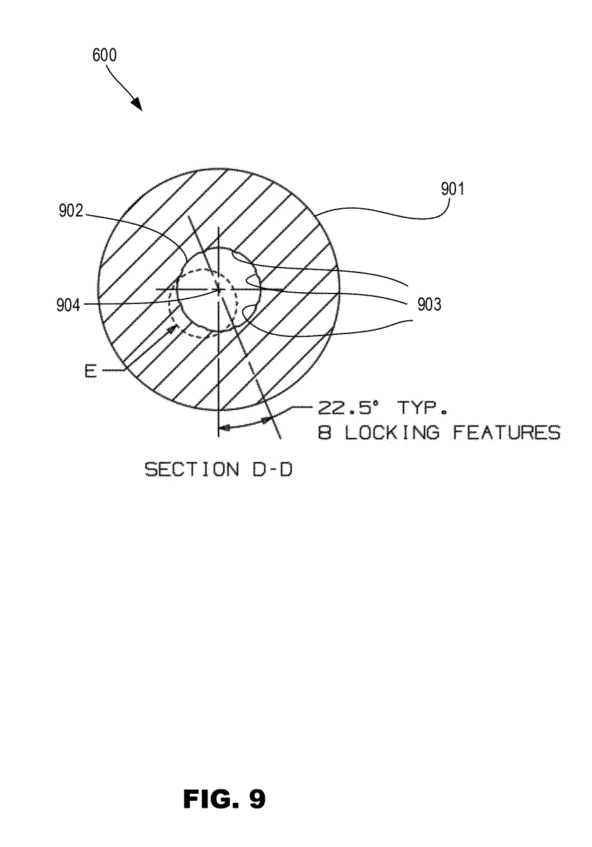

FIG. 9 is a cross-sectional view diagram illustrating a first blow-molded component of a blow-molded stackable receptacle in accordance with at least one embodiment. Concentrically and centrally (with respect to center 904) within a circular outer extent 901 of a recessed area at the bottom of first blow-molded component 600, is defined an axial recess having a longitudinal wall 902. Projecting inwardly from longitudinal wall 902 are a plurality of longitudinal ridges 903. In the example shown, eight longitudinal ridges 903 are defined, but other embodiments may be practiced with other numbers of longitudinal ridges.

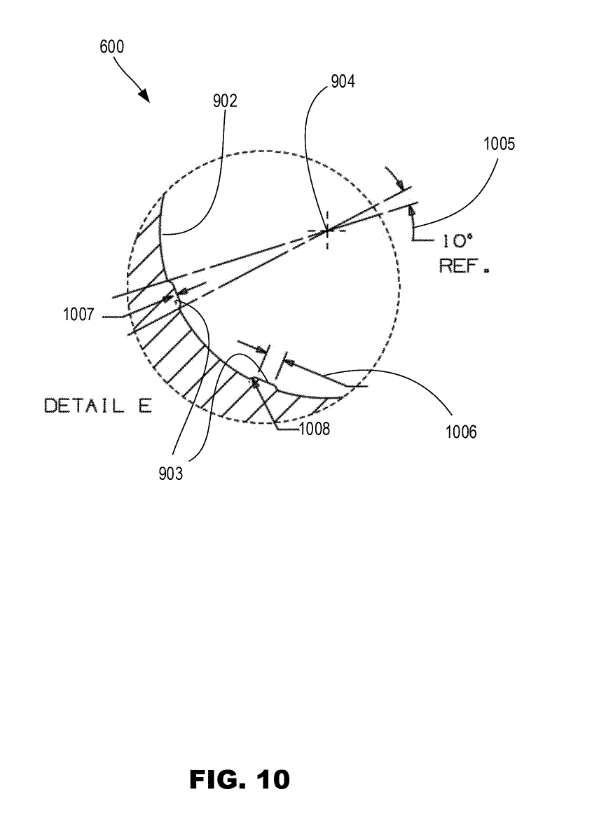

FIG. 10 is a circular inset view diagram illustrating a portion of the cross-sectional view diagram of FIG. 9 in accordance with at least one embodiment. Each of longitudinal ridges 903 has an engagement width 1006 of an engagement surface to engage a portion of a second blow-molded component, such as second receptacle 300. Each of longitudinal ridges 903 has a total width angle 1005. Total width angle 1005 can span a width greater than engagement width 1006. For example, each of longitudinal ridges 903 can have curved or beveled edges 1008 extending along the sides beyond engagement width 1006. Thus, longitudinal ridges 903 can extend convexly (e.g., curvedly, trapezoidally, or the like) inwardly from a surface of longitudinal wall 902. Each of longitudinal ridges 903 has a thickness 1007. Thickness 1007 is measured from the surface of longitudinal wall 902 to an inward apex of a longitudinal ridge 903. The geometric dimensions described above may be identical for all of longitudinal ridges 903, or the geometric dimensions of at least one longitudinal ridge may differ from the geometric dimensions of at least one other longitudinal ridge.

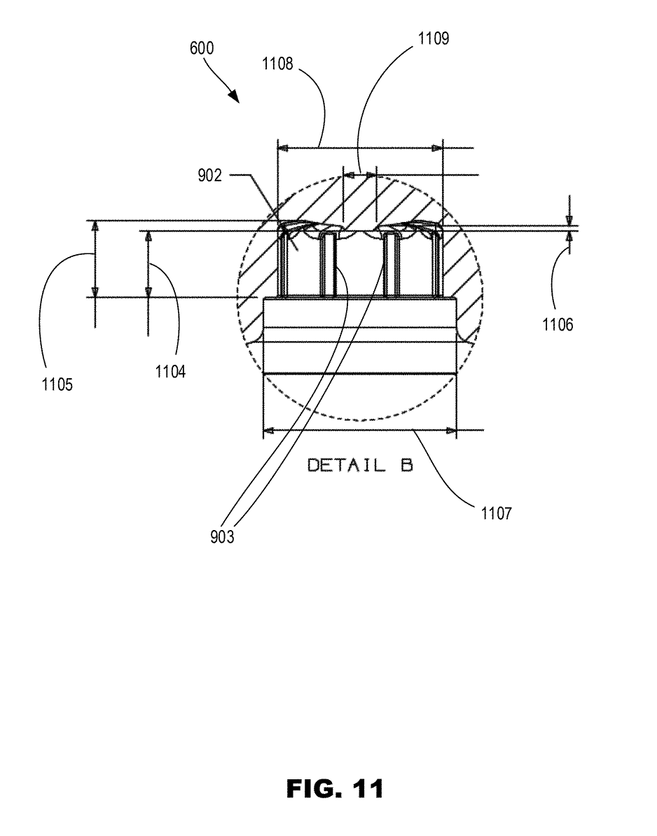

FIG. 11 is a circular inset view diagram illustrating a portion of the cross-sectional view diagram of FIG. 8 in accordance with at least one embodiment. Longitudinal ridge axial length 1104 is a length of longitudinal ridges 903 in an axial direction along a surface of longitudinal wall 902. Longitudinal ridge total length 1104 is a length of longitudinal ridges 903 in an axial direction extending over the surface of longitudinal wall 902 and into the domed portion of the axial recess at the bottom of first blow-molded component 600. Domed portion length 1106 is a length of the domed portion of the axial recess in an axial direction as measured from the lowest extent of center 709 to the lowest extent of the longitudinal ridge of a petal 706 extending inwardly into the domed portion. Neck recess diameter 1107 is a diameter of a neck recess defined by circle 704 to accommodate receiving the neck of a second blow-molded component within the first blow-molded component 600. Longitudinal wall diameter 1108 is the diameter of the approximate cylinder formed by the surface of longitudinal wall 902. Center diameter 1109 is the diameter of center 709, which for example, can be a nub formed from the fusing of cylindrical plastic feedstock during blow-molding to form a closed bottom of first blow-molded component 600.

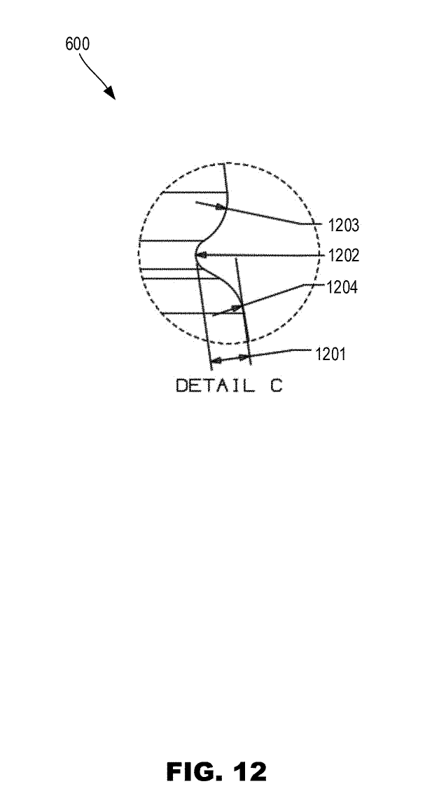

FIG. 12 is a circular inset view diagram illustrating a portion of the side elevation view diagram of FIG. 6 in accordance with at least one embodiment. Each of grooves 624 has an upper convex radius of curvature 1203 leading into the groove from above, a lower convex radius of curvature 1204 leading into the groove from below, and a central concave radius of curvature 1202 within the groove itself. The groove has a groove depth 1201. The minimal insweep of first blow-molded component 600 can have a length and radius of curvature similar to that of upper convex radius of curvature 1203, allowing a junction between the first blow-molded component and a second blow-molded component, when conjoined, to mimic the appearance of one of grooves 624. By covering the bodies of the first blow-molded component and the second blow-molded component with a shrink wrap label, which may define perforations along the junction to promote easy separation, the conformal quality of the shrink wrap label can enhance the similar appearance of the junction to the grooves.

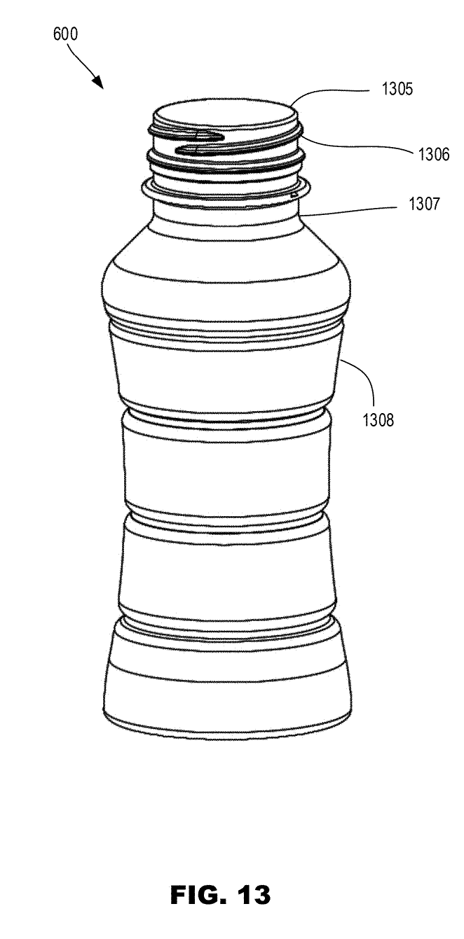

FIG. 13 is a perspective view diagram illustrating a first blow-molded component of a blow-molded stackable receptacle in accordance with at least one embodiment. Upper edge 1305 of finish 619 defines a first blow-molded component axial opening at an upper end of first blow-molded component 600. The first blow-molded component axial opening is centered at an axis 612 of first blow-molded component 600. Finish 619 may be, for example, a threaded finish having a thread 1306 of a helical nature protruding from the surface of finish 619. A convexly curved annular transition 1307 may be provided between neck 620 and shoulder 621. Body 622 may exhibit a generally convex rotationally symmetric shape. For example, an upper portion of body 622 may exhibit a truncated conical shape of reducing diameter toward a central portion of body 622, the central portion of body 622 may exhibit a cylindrical shape of reduced diameter, and a lower portion of body 622 may exhibit a truncated conical shape of reducing diameter toward the central portion. As an example, the upper portion, central portion, and lower portion may be separated by annular grooves around the body 622 of first blow-molded component 600.

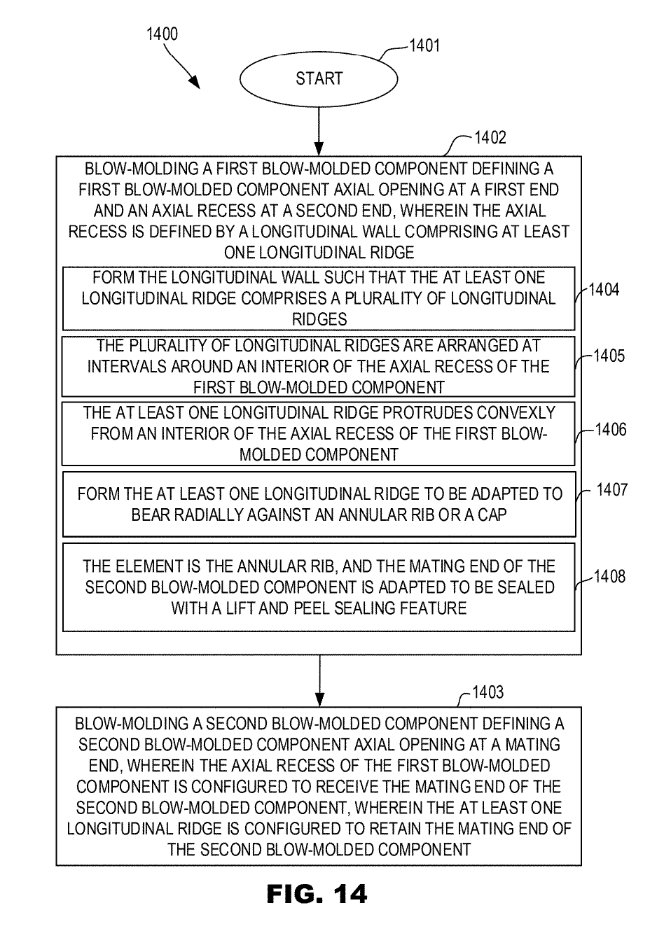

FIG. 14 is a flow diagram illustrating a method for forming a first blow-molded component and a second blow-molded component, wherein a blow-molded stackable receptacle comprises the first blow-molded component and the second blow-molded component, in accordance with at least one embodiment. Method 1400 begins at block 1401 and continues to block 1402. At block 1402, a first blow-molded component defining a first blow-molded component axial opening at a first end and an axial recess at a second end is blow-molded. The axial recess is defined by a longitudinal wall comprising at least one longitudinal ridge. From block 1402, method 1400 continues to block 1403. At block 1403, a second blow-molded component defining a second blow-molded component axial opening at a mating end is blow-molded. The axial recess of the first blow-molded component is configured to receive the mating end of the second blow-molded component. The at least one longitudinal ridge is configured to retain the mating end of the second blow-molded component.

In accordance with at least one embodiment, the blow-molding the first blow-molded component is performed to form the longitudinal wall such that the at least one longitudinal ridge comprises a plurality of longitudinal ridges, as shown in block 1404. In accordance with at least one embodiment, the blow-molding the first blow-molded component is performed to form the longitudinal wall such that the plurality of longitudinal ridges are arranged at intervals around an interior of the axial recess of the first blow-molded component, as shown in block 1405. In accordance with at least one embodiment, the blow-molding the first blow-molded component is performed to form the longitudinal wall such that the at least one longitudinal ridge protrudes convexly from an interior of the axial recess of the first blow-molded component, as shown in block 1406. In accordance with at least one embodiment, the blow-molding the first blow-molded component is performed to form the at least one longitudinal ridge to be adapted to bear radially against an element selected from a group consisting of an annular rib of the mating end of the second blow-molded component and a cap affixed to the mating end of the second blow-molded component, as shown in block 1407. In accordance with at least one embodiment, the element is the annular rib, and the mating end of the second blow-molded component is adapted to be sealed with a lift and peel sealing feature, as shown in block 1408.

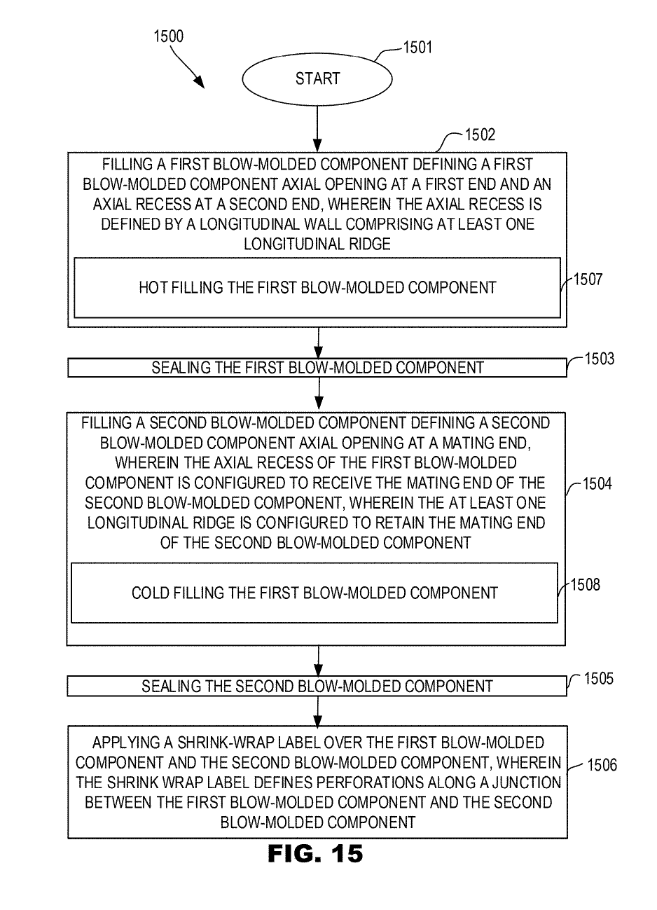

FIG. 15 is a flow diagram illustrating a method for filling and unitizing the components of a blow-molded stackable receptacle in accordance with at least one embodiment. Method 1500 begins in block 1501 and continues to block 1502. At block 1502, a first blow-molded component defining a first blow-molded component axial opening at a first end and an axial recess at a second end is filled with a first liquid-phase product. The axial recess is defined by a longitudinal wall comprising at least one longitudinal ridge. As shown by block 1507, the filling may be a hot filling of the first liquid-phase product that has been heated.

From block 1502, method 1500 continues to block 1503, where the first blow-molded component is sealed. From block 1503, method 1500 continues to block 1504. At block 1504, a second blow-molded component defining a second blow-molded component axial opening at a mating end is filled with a second liquid-phase product. The axial recess of the first blow-molded component is configured to receive the mating end of the second blow-molded component. The at least one longitudinal ridge is configured to retain the mating end of the second blow-molded component. As shown by block 1508, the filling may be a cold filling of the second liquid-phase product that has not been heated.

From block 1504, method 1500 continues to block 1505, where the second blow-molded component is sealed. From block 1505, method 1500 continues to block 1506. At block 1506, a shrink-wrap label is applied over the first blow-molded component and the second blow-molded component. The shrink wrap label defines perforations along a junction between the first blow-molded component and the second blow-molded component.

In accordance with at least one embodiment, a blow-molded stackable receptacle comprises a first blow-molded component defining a first blow-molded component axial opening at a first end and an axial recess at a second end, wherein the axial recess is defined by a longitudinal wall comprising at least one longitudinal ridge, and a second blow-molded component defining a second blow-molded component axial opening at a mating end, wherein the axial recess of the first blow-molded component is configured to receive the mating end of the second blow-molded component, wherein the at least one longitudinal ridge is configured to retain the mating end of the second blow-molded component. In accordance with at least one embodiment, the at least one longitudinal ridge comprises a plurality of longitudinal ridges. In accordance with at least one embodiment, the plurality of longitudinal ridges are arranged at intervals around an interior of the axial recess of the first blow-molded component. In accordance with at least one embodiment, the at least one longitudinal ridge protrudes convexly from an interior of the axial recess of the first blow-molded component. In accordance with at least one embodiment, the at least one longitudinal ridge eliminates radial freedom of the mating end of the second blow-molded component with respect to the first blow-molded component. In accordance with at least one embodiment, the at least one longitudinal ridge bears radially against an element selected from a group consisting of an annular rib of the mating end of the second blow-molded component and a cap affixed to the mating end of the second blow-molded component. In accordance with at least one embodiment, the element is the annular rib, and the mating end of the second blow-molded component is sealed with a lift and peel sealing feature.

In accordance with at least one embodiment, a blow-molded stackable receptacle comprises a first receptacle defining a first receptacle opening at a first end and an bottom cylindrical rise at a second end, wherein the bottom cylindrical rise is defined by a longitudinal wall comprising at least one tab, and a second receptacle defining a second receptacle opening at a mating end, wherein the bottom cylindrical rise of the first receptacle is configured to receive the mating end of the second receptacle, wherein the at least one tab is configured to retain the mating end of the second receptacle. In accordance with at least one embodiment, the at least one tab comprises a plurality of tabs. In accordance with at least one embodiment, the plurality of tabs are arranged at intervals around an interior of the bottom cylindrical rise of the first receptacle. In accordance with at least one embodiment, the at least one tab protrudes convexly from an interior of the bottom cylindrical rise of the first receptacle. In accordance with at least one embodiment, the at least one tab eliminates radial freedom of the mating end of the second receptacle with respect to the first receptacle. In accordance with at least one embodiment, the at least one tab bears radially against an element selected from a group consisting of an annular rib of the mating end of the second receptacle and a cap affixed to the mating end of the second receptacle. In accordance with at least one embodiment, the element is the annular rib, and the mating end of the second receptacle is sealed with a lift and peel sealing feature.

Finally, while the present invention has been described above with reference to various exemplary embodiments, many changes, combinations and modifications may be made to the exemplary embodiments without departing from the scope of the present invention. For example, the various components may be implemented in alternative ways including, but not limited to, use of different materials for both the receptacles and the blow-molding tooling and different fill materials. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present disclosure.

What is claimed is:

1. A blow-molded stackable receptacle comprising:
a first blow-molded component defining a first blow-molded component axial opening at a first end and an axial recess at a second end, wherein the axial recess is defined by a longitudinal wall comprising at least one longitudinal ridge; and
a second blow-molded component defining a second blow-molded component axial opening at a mating end, wherein the axial recess of the first blow-molded component is configured to receive the mating end of the second blow-molded component, wherein the at least one longitudinal ridge is configured to retain the mating end of the second blow-molded component.

2. The blow-molded stackable receptacle of claim 1 wherein the at least one longitudinal ridge comprises a plurality of longitudinal ridges.

3. The blow-molded stackable receptacle of claim 2 wherein the plurality of longitudinal ridges are arranged at intervals around an interior of the axial recess of the first blow-molded component.

4. The blow-molded stackable receptacle of claim 1 wherein the at least one longitudinal ridge protrudes convexly from an interior of the axial recess of the first blow-molded component.

5. The blow-molded stackable receptacle of claim 1 wherein the at least one longitudinal ridge eliminates radial freedom of the mating end of the second blow-molded component with respect to the first blow-molded component.

6. The blow-molded stackable receptacle of claim 1 wherein the at least one longitudinal ridge bears radially against an element selected from a group consisting of an annular rib of the mating end of the second blow-molded component and a cap affixed to the mating end of the second blow-molded component.

7. The blow-molded stackable receptacle of claim 6 wherein the element is the annular rib, and the mating end of the second blow-molded component is sealed with a lift and peel sealing feature.

8. A method comprising:
blow-molding a first blow-molded component defining a first blow-molded component axial opening at a first end and an axial recess at a second end, wherein the axial recess is defined by a longitudinal wall comprising at least one longitudinal ridge;
blow-molding a second blow-molded component defining a second blow-molded component axial opening at a mating end, wherein the axial recess of the first blow-molded component is configured to receive the mating end of the second blow-molded component, wherein the at least one longitudinal ridge is configured to retain the mating end of the second blow-molded component.

9. The method of claim 8 wherein the blow-molding the first blow-molded component forms the longitudinal wall such that the at least one longitudinal ridge comprises a plurality of longitudinal ridges.

10. The method of claim 9 wherein the blow-molding the first blow-molded component forms the longitudinal wall such that the plurality of longitudinal ridges are arranged at intervals around an interior of the axial recess of the first blow-molded component.

11. The method of claim 8 wherein the blow-molding the first blow-molded component forms the longitudinal wall such that the at least one longitudinal ridge protrudes convexly from an interior of the axial recess of the first blow-molded component.

12. The method of claim 8 wherein the blow-molding the first blow-molded component forms the at least one longitudinal ridge to be adapted to bear radially against an element selected from a group consisting of an annular rib of the mating end of the second blow-molded component and a cap affixed to the mating end of the second blow-molded component.

13. The method of claim 12 wherein the element is the annular rib, and the mating end of the second blow-molded component is adapted to be sealed with a lift and peel sealing feature.

14. A blow-molded stackable receptacle comprising:
a first receptacle defining a first receptacle opening at a first end and an bottom cylindrical rise at a second end, wherein the bottom cylindrical rise is defined by a longitudinal wall comprising at least one tab; and
a second receptacle defining a second receptacle opening at a mating end, wherein the bottom cylindrical rise of the first receptacle is configured to receive the mating end of the second receptacle, wherein the at least one tab is configured to retain the mating end of the second receptacle.

15. The blow-molded stackable receptacle of claim 14 wherein the at least one tab comprises a plurality of tabs.

16. The blow-molded stackable receptacle of claim 15 wherein the plurality of tabs are arranged at intervals around an interior of the bottom cylindrical rise of the first receptacle.

17. The blow-molded stackable receptacle of claim 14 wherein the at least one tab protrudes convexly from an interior of the bottom cylindrical rise of the first receptacle.

18. The blow-molded stackable receptacle of claim 14 wherein the at least one tab eliminates radial freedom of the mating end of the second receptacle with respect to the first receptacle.

19. The blow-molded stackable receptacle of claim 14 wherein the at least one tab bears radially against an element selected from a group consisting of an annular rib of the mating end of the second receptacle and a cap affixed to the mating end of the second receptacle.

20. The blow-molded stackable receptacle of claim 19 wherein the element is the annular rib, and the mating end of the second receptacle is sealed with a lift and peel sealing feature.
